(19) United States
(12) Patent Application Publication
(10) Pub. No.: US 2002/0169941 A1
(43) Pub. Date: Nov. 14, 2002

(54) Dynamic processing method

(76) Inventor: Mary Susan Huhn Eustis, Lexington, MA (US)

Correspondence Address: CHARLES HIEKEN, Fish & Richardson P.C., 225 Franklin Street, Boston, MA, 02110-2804, US

(21) Appl. No.: 09/852,882

(22) Filed: May 10, 2001

(51) Int. Cl. G06F 15/00; G06F 15/76; G06F 9/00

(52) U.S. Cl. 712/10

(57) ABSTRACT

A system and method is presented for simultaneous processing of information by providing a matrix having numerous cells, each of which has at least one processor and pages having a combination of format counters, data pointers and process counters. The cells may be connected to an area of random access memory, which is addressable, with the connection being dynamically re-allocable to other areas of random access memory. Instructions and registers are located in random access memory areas. The cells can process information addressable over one or more networks, including without limitation the Internet, executing instructions pointed to by at least one process counter.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The invention relates to a method and system for dynamic simultaneous processing of information, and more specifically to a matrix of processor systems dynamically linked to memory which is used to implement pointers.

### BACKGROUND

Intuitive use of computers depends on being able to connect to information in the same way (analogously) one can dial a telephone to connect to another person far away. Personal control of information depends on data having the analog of telephone numbers, i.e. locations that are addressable remotely, and those addresses being published in directories. Proprietary and confidential information must be locked in secure locations with access protected, but to be useful, the information needs to be able to be accessed remotely.

Intuitive use of computers requires, among other things, information configuration and constraint management. Information needs to be able to be processed without hiding it in registers where it gets covered over every millisecond or so. The processes are basically simple, taken on one at a time. It is only in the aggregate that the processes become seemingly complex. The use of traditional registers (an inherently linear concept) introduces a needless artificial complexity into the analysis of problems.

Problems that cannot be solved by a particular person in a particular job relate to the seemingly most insignificant issues. “How do I find out the granular information relating to how many servers I shipped this year?” “How do I find out this information in real time?” “How do I know the size of the calcium deposits that were dangerous to my patients?” “How do analyze the effectiveness of my keyword submissions?” “How do I figure out what is interesting and meaningful in this ton I data I collected from my spectrometer?” “How do I understand the nuance of this patient information relating to blood pressure and cardiac data?” “How can I find out what my associates in my law firm are working on so I can mange them?”

People are basically faced with the dilemma, “I know that the information is in the computers somewhere but where is it? And how do I get a programmer to find the stuff I need, when I do not really know where the stuff is until we start trying to find it? Even if I can find the information in different places, how do I keep collecting it on an ongoing basis and do things that are simple analysis so I can detect trends?”

Traditional operating systems work to store, organize files, print, and display information. Those continue to be significant in their own context, but are not relevant to the task of the Internet operating system.

### SUMMARY

In one aspect, the present inventions relates to a method of simultaneous processing of information by providing a matrix having numerous cells, each of which has at least one processor and pages having a combination of format counters, data pointers and process counters. The cells may be connected to an area of random access memory, which is addressable, with the connection being dynamically re-allocable to other areas of random access memory. Instructions and registers are located in random access memory areas. The cells can process information addressable over one or more networks, including without limitation the Internet, executing instructions pointed to by at least one process counter.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a dynamic processor.

### DETAILED DESCRIPTION

The present invention, in one aspect, supports breaking problems into in small pieces. These small pieces are put into individual computer “cells” (described below) arrayed in one or more matrices so that that as many cells as may be needed (potentially billions) may process simultaneously. Systems can work in real time or batch format. They can gather information by polling, or by search and get mechanisms.

The present invention may be utilized in the context of an operating system for the Internet with the ability of go out the Internet, pick up data or information, put that information into a cell, and then do something analytical with the information to create a new result. The Internet operating system works in real time, sometimes over a period of years to collect and manage disparate types of information. The information is set in one place and dealt with there, not moved around for the purposes of programming.

It is useful to have some background of a context in which the invention may be beneficially utilized.

Now that relevant information is spread out all over a campus or region, it is no longer useful just to think about processing information inside one computer. By creating a computer that displays onto a large wall size or chalkboard size presentation of the matrix, we have better visualization of the matrix and the information than we do on a small electronic display. The two types of presentation (individual PC and matrix) complement each other.

An operating system for the present invention is a combination of format, pointer, and instruction counters that permit the user to control the collection, format, and analysis of the information to be collected and collected. The operating system depends on mission critical messaging that provides cross platform, cross application delivery of information. There are existing format adapters, downloadable from the Internet and other locations. to provide access to information in applications. The operating system may also use software that is able to go out to the net and get information from a particular URL.

A matrix computer has cells in a matrix, each cell divided into layers (also called pages) that contain definitions of the information, automate the get function for getting information, and automate the analysis of the information that is collected. Multiple pages provide visualization of what is going on inside the implementation of the instructions.

The operating system use set up processes that are different from a program. A program is an analysis that is put in place by a programmer that deals with the significant complexity of registers that are continuously hiding information in order to implement successive instructions.

A set up process is different. It is a set of rules given to a machine that are all out in the open and visible to a user. A set up process defines a set of processes (e.g. mathematical, logical, comparative, increment etc.) to apply to one constraint. Then the next constraint is tackled, and the rules are applied to all the cells that are relevant to this rule.

A set up process utilizes successive and asynchronous instructions that can be viewed successively or by layers of similar instructions that can be viewed successively or by layers of similar instructions out of order of the operation. In addition, the set up process breaks out layers of similar operation, i.e. definition of registers and variables or constants as a format layer that are not successive operations, but independent operations that are simultaneous rather than successive operations. In addition, links and pointers to information are broken out as simultaneous asynchronous operations rather than successive instructions.

Multiple types of instructions or operators can occur simultaneously using a set up process, the system is not limited by or to successive operations, rather, format, linking, information retrieval from storage, information retrieval from the Internet or a network, and processing operations can be performed simultaneously using a set up process, with each type of operation intuitive and easily visible to the matrix operator.

Separate registers can be set up to deal with one type of rule, then the next rule of similar type is dealt with. Thus all the cells that need addition are defined, then all the cells that use compare functions, then all the cells that need division. This is an optional way to set up a process.

The set up process mimics an assembly in which it is far more efficient than building a program one step at a time, in successive steps. By combining all the similar instructions and putting those rules on a separate page, it is easier to look at what is happening and change it in an intuitive fashion.

By permitting viewing of instructions, formats and links successively or by layer of similar function, the matrix user gains more control over the process and operations performed because there are multiple ways to control the same operation. This is the measure of the difference between a set up process and a program.

When a set up process is used, it may be useful to do all the compare operations, then all the logical ors, and so forth, instead of organizing the processing of information in successive stacks applying one rule after the other, sometimes it is useful to apply or look at all instances of a similar rule, e.g. all jumps after a greater than or less than system.

Even when the analysis is built one step at a time, it is checked for accuracy by looking at all the similar instructions simultaneously. Steps can be duplicated and reused many times.

These matrices of cells provide a way to perform billions of independent operations simultaneously. Each cell in a matrix may have its own separate processor. Each cell has a variety of different types of counters that perform different functions, such as:

Format Counters: format counters relate to definition of the type of data and well as the traditional formats associated with creating reports and presentation. Format counters can differentiate characteristics of the information, in radiology data for example, all calcium deposit data, all women, all men, all broken arms, and so forth. The formats can be set up separately on separate pages, but relate to the same information. Each format can be assigned a separate page so that it possible to configure the formats relating to a cell by going to that page and not worrying about the other aspects of the information relating to a cell. The format counter contains is a set of instructions that identify format of information, such as where the location is placed in a field, whether the location contains an alphanumeric or numeric quantity, whether it is left justified or right justified, whether it is all caps if alphanumeric, and so forth.

Data pointers: The data pointers relate to key files or to a pointer to a URL, a pointer to information in an application, and the like. The pointer may also contain adapters and information about formatting data thus permitting dialing out to “memory” having an address on the Internet or local network and picking up the information in a manner that is seamless to the user, in the same way that we use a telephone to make a voice telephone call. The person dialing the telephone is oblivious to the complexities of the telephone-switching network and the ways of going between networks; the person only knows that a connection has been made. Because there are so many places to get information from a network, it is useful to have a matrix that can format each cell separately to go out and get information, wherever it is being stored. Information is gathered in cells and used in different ways at different times. There are means for going into a database, an application, or out to the Internet to get information. Then the information needs to be put in a standard format. The data pointer tells where information is located in the different types of storage devices in the matrix computer, such as a diskette drive, hard drive, CD ROM, or RAM.

Process Counters: The process counters define processes associated with particular information. For example, the information may have an associated process as simple as one that represents that there is a number residing on a piece of paper. The process utilizes a set of operators such as, for example, add, subtract, multiply, divide, logical and, logical or, and so forth. Further, the process may involve instructions, such as move and so forth. The processing counters use modified instruction sets and unique register systems to process independently in each cell. The instructions sets may be relatively simple and vary between cells. The instruction sets may be downloaded from the Internet to create unique configurations for each cell of the matrix.

The matrix computer provides a way of using memory to do processing. The registers can be unique for each operation so that it is always possible to go see what is happening in a register at any time. The registers are accessed through a page or set of pages associated with a cell or set of cells.

Using the matrix computer permits us to set up problems in pieces and solve those problems in a nonlinear manner with simultaneous processing inside a matrix. The simultaneous processing means that there may be a thousand, or a million, or a billion processes are going on at the same time inside the matrix. Or, the processing may be going on over time, going out and getting information in real time and processing that information over a year or more, receiving reports all the while. Once the problem is set up, the matrix knows how to go out and poll information locations, update the matrix, and provide periodic reports.

The process is inherently n-dimensional. Whatever variables a user needs to track can be set up on a display board. The board is a representation of a cell or combination of cells within a matrix that does not have any linear processing scheme or fixed set of registers. Each square in the display board can represent some piece of information that needs to be processed in the context of other information. Then the multiple processors inside multiple cells of the matrix do the processing in real time and present updated information on the display board such as a stock exchange big board or a commodities exchange board.

Each cell may have multiple layers of formatting rules that relate to traditional formats like data, money, alpha numeric, and font. There are other layers of format as well, like name, address, patient ID number, social security numbers, key words, and password for example. Then there are other types of format that may relate to configurations within the information itself, inside of a database. Radiation data may relate to bone breaks, calcium, or parts of the body.

Another type of format is a data pointer, or key file that points to information stored in memory. There are multiple types of key file, a traditional key file, a storage buffer, an array, an e-mail address book, a URL, for locating information on the Internet, and so forth. A key is an address book that points to information and is associated with a number that lets a cell dial up the information and get it.

There is a separate type of constraint: the address of the data, whether it be on a computer or down in an oil well, or in the washing machine, or the utility meter. Data is in a range of places, and we need to be able to set up ways to collect if from several places at the same time. It is useful to be able to collect information from many places at the same time, or from the same place at different times, or even from many places at different times. This is the second level of n-dimensional processing.

The third level of processing relates to the operations that are performed on the information. In this case as well, there are several types of operations including increment and decrement (either by one or by some modulus); all the arithmetic operations (add, subtract, multiply divide, plus compare greater than less than, and equal to) and compare functions useful for creating loops, creating exits and processing repetitively as long as some logical condition exists.

In addition there are some operators relating to cells in a matrix: create a link, get a field, increment or decrement a key field, increment or decrement contents of a field, and increment or decrement an address. Increment and decrement may be shown in an example: Suppose a user wants a macro that grabs some text and puts it into a file, then grabs the next set of text and puts it into a new file. The macro should be able to increment a pointer to the next text, and increment the file name to create a new file so it does not keep writing over the old file. Such pointers may exists anywhere within the matrix or even in remote storage locations.

This approach has no dedicated registers where information is continuously being covered over as new information arrives and is processed. There are as many “registers” as the person creating the matrix wants. Operations take place in memory in the broadest sense of the word: anywhere there is alterable storage. One can look at the layers and pages of the register pointers to see what is happening in each cell at any time.

It is useful to be able to increment addresses. Similar information is traditionally stored sequentially. When this is the case, it is useful to pick up the first field, and then do an increment command to pick up the next field. The addresses may be incremented by one or by a modulus. Traditionally addresses are in the memory of the computer being used. In addition, addresses may refer to a link to an application, a storage area network, a database, or the Internet.

In addition, each cell of the matrix has its own registers in memory. The user can set up the number and configuration of registers as desired. The instructions sets vary by cell as well. Each cell has its own instruction set. There are pages dedicated to registers and pages dedicated to instructions so that by clicking on a cell and the desired page, it is always possible to look at what is going on with respect to a register, with respect to instruction sets that make the operators work.

Thus, some problems may require a complex instruction set, some a very simple set that is enormously repetitive. Whatever is needed, the cells can be configured to provide. The pages give control and make the operations visible form many different aspects of the analysis.

It is envisioned that the matrix is normally used to do calculations, not to do publishing and report formatting. The formatting in the matrix relates to formatting information so that it can be useful to solve problems. The matrix has a way to ship data out to another program that does the presentation of information.

The matrix can be divided into sets where each set acts as a cell, with all the characteristics of a cell. In addition, each cell within the set of cells can act independently, so that n dimensions can be created in any direction, making the matrix understandable and useful at the same time.

It is anticipated that boards of matrices can be set up that operate over a year or period of years to collect information in real time or in batch mode, and then perform calculations that show changes, inflections, trends, and analysis of events.

The matrix provides a way to perform billions of independent operations simultaneously. Because we are getting pieces of information that relate to analysis of a particular problem from different computers and servers with different operating systems and different platforms, it is useful to have ways of collecting those pieces of information in one place, and of analyzing those pieces of information independently in the same matrix.

Once digital processing operations are conducted in a dynamic processing mode, information can be assigned permanent locations. Dynamic processing means that the instruction sets and program counters are mobile, they move around while the data stays static or relatively static.

The messaging systems become the operating systems of the Internet. Instructions can be associated with each or a set of spread sheet cells. Users may use any of a variety of existing communications technologies to dial up for data and instruction sets located in a server of on the Internet in the same manner as a person currently dials up for a voice call to reach another person.

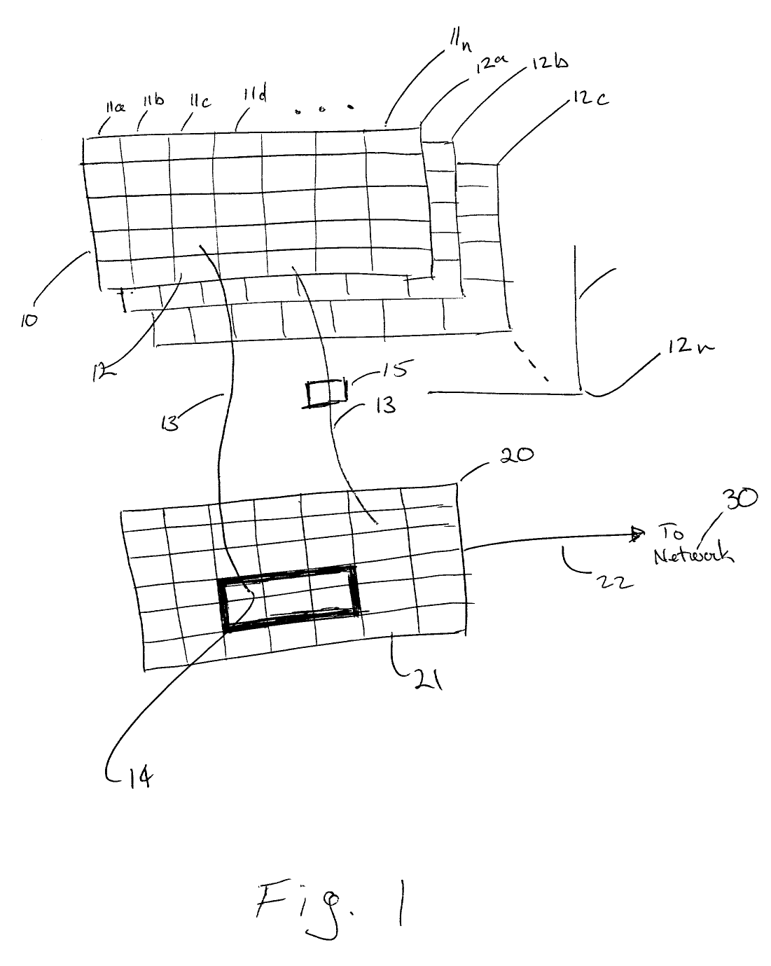

Referring to FIG. 1, a matrix 10 of cells 11 (including 11a, 11b, 11c, 11d and 11n by way of example) are interconnected on a bus 13 through a switch 15. The matrix 10 of cells 11 is arranged into layers (pages) 12 (including 12a, 12b, 12c and 12n by way of example). The bus 13 interconnects cells 11 to selected portions of a RAM memory 20. The RAM 20 is in turn inter-connectable on a line 22 to the Internet or a network server where instruction sets and other information can be downloaded to RAM 20 locations. A processor (a counter) in a particular memory cell 21 can access other memory locations in RAM 20 which may contain counters (processors) or instructions that are more sophisticated than that in cell 21 By using a location within memory as a counter it can be used to point to other locations (cells) that may in turn contain counters or instructions.

Each cell 11 has multiple sub components that may consist of memory locations having counters, instructions, or memory, all of it pure memory with different functions. Each call supports asynchronous (with respect to other cells) self contained processing of information inside the cell of the matrix for a number of different types of counters such as format, location, or traditional instruction processing, and for multiple instances of the same type of counter within the cell. Supporting asynchronous simultaneous self contained processes of information inside multiple cells, conceivably billions or more simultaneously performing multiple processes with millions operations going on inside each cell of the matrix are possible. The multiprocessor manages instructions, formats and links or pointers dynamically, and is the operating system for the matrix. The dynamic processor manages locations dynamically, and is the operating system for the Internet.

Memory can be used to point to other locations in a network, determined by a key file, denoted by a URL, or otherwise linked. Counters can be used to step through instructions, or they can denote registers within a cell that contains the results of operations, or point to information. Counters can be used to create formats.

There is a processor counter in each cell. Cells may contain one or several of the same or different counters, format, link, or processor.

If data aggregations are assigned unique numbers then each piece of data is addressable and accessible via the Internet or other network.

The line 22 that interconnects the RAM 20 and the network 30 may have a counter that provides dynamic re-allocation of the cells in RAM 20.

There is a matrix display mechanism that is divided into numbered cells 1a, 1b, 2a, 2b, . . . 11 . . . The matrix cells 11 from the display spread sheet 10 represent memory 20 that is connected to other memory 20 on a line 13. Cells 11 may be connected 12 through lines 13 (only two lines are shown for simplicity of visualization) to other memory cells 21 with a plug 14 in the random access memory 20.

The line 13 may have a switch 15 that permits re-direction of the link from a cell 11 to another cell 21. The instructions executed by a cell are a subset of the random access memory, without the traditional processor and logic unit that are contained in a linear processor. The process counter is a part of the memory and the registers are part of memory, configured by the format counters. Each cell becomes a linear processor that can interconnect dynamically to the cells of the matrix.

Cells 11, 11a, 11b, 11c etc. are dynamically linked on a line 13 to random access memory 20. The memory 20 itself may contain instructions in cells 21 and be allocated as registers in cells 21, creating direct connection on a line 13 between the display cells 11 and the registers 21 used for computation. Because the instructions and the formats and the data are all in one place in the memory 20, creating a computation or program is more intuitive than where the instructions and program counter are located separately form the display cells. In this manner, operations can be performed simultaneously in a billion cells of the matrix.

A number of embodiments of the invention have been described. Nevertheless, it will be understood that various modifications may be made without departing from the spirit and scope of the invention. Accordingly, other embodiments are within the scope of the following claims.

What is claimed is:

1. A method of simultaneous processing of information comprising:
providing a matrix comprising a plurality of cells, each cell of the plurality of cells comprising at least one processor and at least one page, the at least one page comprising one selected from the set consisting of format counters, data pointers and process counters;
connecting at least one cell to at least one area of random access memory, the area comprising at least one addressable location, and the connection being dynamically re-allocable to at least a second area of random access memory;
locating instructions and registers in random access memory areas;
processing information by at least one of the plurality of cells executing instructions pointed to by at least one process counter.
